(19) United States
(12) Patent Application Publication
(10) Pub. No.: US 2026/0253281 A1
(43) Pub. Date: Aug. 27, 2026

(54) GRAPHICAL ELEMENT MANAGEMENT

(71) Applicant: Capital One Services, LLC, McLean, VA (US)

(72) Inventors: Bryan TAMAYO, Allen, TX (US); Nisha BHATT, Frisco, TX (US); Lilian OLIVEIRA, Dallas, TX (US)

(21) Appl. No.: 19/062,867

(22) Filed: Feb. 25, 2025

(51) Int. Cl. G06T 11/60; G06F 3/04845; G06T 13/80

(52) U.S. Cl. CPC G06T 11/60; G06F 3/04845; G06T 13/80

(57) ABSTRACT

In some implementations, a system may receive user context information indicating that a user is associated with a first stage of a multi-stage user procedure. The system may identify, based on the user context information, a first graphical element state associated with a first graphical element complexity level. The system may identify a first graphical element associated with the first graphical element state and transmit an indication to display the first graphical element. The system may receive user interaction information indicating that the user is associated with a second stage of the multi-stage user procedure. The system may identify, based on the user interaction information, a second graphical element state associated with a second graphical element complexity level. The system may identify a second graphical element that is associated with the second graphical element state and transmit an indication to display the second graphical element.

### BACKGROUND

A web browser may provide a graphical user interface that presents web pages. Web pages often incorporate icons that can be seen by users visiting the web pages. These icons can include various depictions relating to material on the web pages.

### SUMMARY

Some implementations described herein relate to a system for graphical element management. The system may include one or more memories and one or more processors communicatively coupled to the one or more memories. The one or more processors may be configured to receive user context information indicating that a user is associated with a first stage of a multi-stage user procedure. The one or more processors may be configured to identify, based on the user context information, a first graphical element state associated with a first graphical element complexity level. The one or more processors may be configured to identify a first graphical element associated with the first graphical element state, wherein the first graphical element comprises a first scalable vector graphics (SVG) element. The one or more processors may be configured to transmit an indication to display the first graphical element. The one or more processors may be configured to receive user interaction information indicating that the user is associated with a second stage of the multi-stage user procedure. The one or more processors may be configured to identify, based on the user interaction information, a second graphical element state associated with a second graphical element complexity level. The one or more processors may be configured to identify a second graphical element that is associated with the second graphical element state, wherein the second graphical element comprises an SVG element. The one or more processors may be configured to transmit an indication to display the second graphical element.

Some implementations described herein relate to a method of graphical element management. The method may include receiving user context information indicating that a user is associated with a first stage of a multi-stage user procedure. The method may include identifying, based on the user context information, a first graphical element state associated with a first graphical element complexity level. The method may include identifying a first graphical element associated with the first graphical element state. The method may include transmitting an indication to display the first graphical element. The method may include receiving user interaction information indicating that the user is associated with a second stage of the multi-stage user procedure. The method may include identifying, based on the user interaction information, a second graphical element state associated with a second graphical element complexity level. The method may include identifying a second graphical element that is associated with the second graphical element state. The method may include transmitting an indication to display the second graphical element.

Some implementations described herein relate to a non-transitory computer-readable medium that stores a set of instructions. The set of instructions, when executed by one or more processors of a device, may cause the device to receive user context information indicating that a user is associated with a first stage of a multi-stage user procedure. The set of instructions, when executed by one or more processors of the device, may cause the device to identify, based on the user context information, a first graphical element state associated with a first graphical element complexity level. The set of instructions, when executed by one or more processors of the device, may cause the device to identify a first graphical element associated with the first graphical element state. The set of instructions, when executed by one or more processors of the device, may cause the device to transmit an indication to display the first graphical element. The set of instructions, when executed by one or more processors of the device, may cause the device to receive user interaction information indicating that the user is associated with a second stage of the multi-stage user procedure. The set of instructions, when executed by one or more processors of the device, may cause the device to identify, based on the user interaction information, a second graphical element state associated with a second graphical element complexity level. The set of instructions, when executed by one or more processors of the device, may cause the device to identify a second graphical element that is associated with the second graphical element state. The set of instructions, when executed by one or more processors of the device, may cause the device to transmit an indication to display the second graphical element in accordance with a lazy loader.

### BRIEF DESCRIPTION OF THE DRAWINGS

FIGS. 1A-1D are diagrams of an example implementation associated with graphical element management, in accordance with some embodiments of the present disclosure.

FIG. 2 is a diagram of an example functional workflow associated with adaptive cursor or tooltip management, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with graphical element management, in accordance with some embodiments of the present disclosure.

FIG. 5 is a flowchart of an example process associated with graphical element management, in accordance with some embodiments of the present disclosure.

### DETAILED DESCRIPTION

The following detailed description of example implementations refers to the accompanying drawings. The same reference numbers in different drawings may identify the same or similar elements.

Many websites use static graphical elements that are always displayed within a web page. However, such static graphical elements may be too complex for a user or may fail to provide sufficient detail for a user during focused exploration. Overly complex static graphical elements may create a poor user experience, consume excessive computing resources (e.g., processing resources and memory resources) that are needed for the user device to generate and display the overly complex static graphical elements and that are needed for one or more server devices to serve the overly complex static graphical elements to the user device, and consume excessive network resources that are needed for communications between the user device and the server device. Undetailed graphics may cause the user to navigate through a large number of web pages to find relevant information, which can create a poor user experience, consume excessive computing resources (e.g., processing resources and memory resources) that are needed for the user device to generate and display the web pages and that are needed for one or more server devices to serve the web pages to the user device, and consume excessive network resources that are needed for communications between the user device and the server device. Furthermore, displaying different versions of the same graphical element may involve separately tracking and updating each version of each graphical element for each web page of a web site. Such separate tracking and updating may create a poor user experience due to a lack of consistency across different versions, graphical elements, and/or web pages. Additionally, or alternatively, separate tracking and updating may consume excessive computing resources (e.g., processing resources and memory resources) used for information processing, such as tracking each version of each graphical element for each web page of the web site and determining when and how to update displays of the graphical elements.

Some implementations described herein enable real-time, data-driven adaptation of graphical element complexity based on user-specific information, such as user context, user interactions, user engagement, or the like. In some examples, a dynamic adaptive graphical element system may determine an appropriate graphical element complexity level based on the user-specific information and prompt a corresponding graphical element to display on the web page. In some examples, the system may dynamically update the web page to display a different graphical element having a different graphical element complexity level based on additional user-specific information. The graphical elements may include, and be modified based on, one or more colors, text, shapes, visual effects, animations, shadows, gradients, or the like. In some examples, as a user progresses through a user journey via the website, the system may intelligently adjust from high-complexity graphical elements (e.g., graphical elements with highly detailed, multi-layered designs) to low-complexity graphical elements (e.g., graphical elements with fewer details and/or a simpler form). For example, the system may automatically select a most appropriate graphical element for a current stage in the user journey. For example, text in a graphical element may be visible in some instances and hidden in others. In some examples, each graphical element may be associated with a state that indicates a complexity of the graphical element. Thus, the system may use a state machine to track and/or update a multitude of graphical elements using two or more such states. In some examples, the graphical elements may be SVG elements that operate within a modular SVG element framework within a user interface. For example, the system may dynamically generate and/or select one or more modular SVG graphical elements in real-time.

In this way, computing resources and/or network resources may be conserved by tailoring graphical element complexity to a given user. For example, dynamically identifying a graphical element having an appropriate complexity for a user may help to ensure that graphical elements are not overly complex, thereby conserving computing resources that would otherwise be used for the user device to generate and display the overly complex graphical elements and that are needed for one or more server devices to serve the overly complex graphical elements to the user device, and consume excessive network resources that are needed for communications between the user device and the server device. Additionally, or alternatively, dynamically identifying a graphical element having an appropriate complexity for a user may help to ensure that graphical elements are not under-detailed, and thereby reduce an amount of navigation performed by the user to other web pages, which may conserve computing resources that would otherwise be used for the user device to generate and display the web pages and that are needed for one or more server devices to serve the web pages to the user device, and consume excessive network resources that are needed for communications between the user device and the server device. Furthermore, associating graphical elements with states that indicate respective graphical element complexities may help to streamline how the system tracks and updates the graphical elements, thereby conserving computing resources (e.g., processing resources and memory resources) that would otherwise be used for tracking each version of each graphical element for each web page of the web site and determining when and how to update displays of the graphical elements. For example, the states may ensure consistent behavior across different user interactions and user journey stages. Furthermore, the techniques described herein make data easier to access by enhancing a user interface, thereby improving a user experience, user engagement, user interaction, decision-making, and accessibility at each stage of the user journey in online platforms, enhancing user-friendliness of a user device and the user interface, and improving the ability of a user to use the user device. For example, the system may improve user interaction by personalizing graphical element complexity, thereby enhancing recognition and navigation throughout the user journey. Additionally, or alternatively, the system may offer a cohesive and context-aware user experience by providing a personalized, efficient, engaging, and responsive user interface, and tailored, engaging, and accessible navigation. For example, the system may provide smooth and contextually appropriate changes to a graphical interface display.

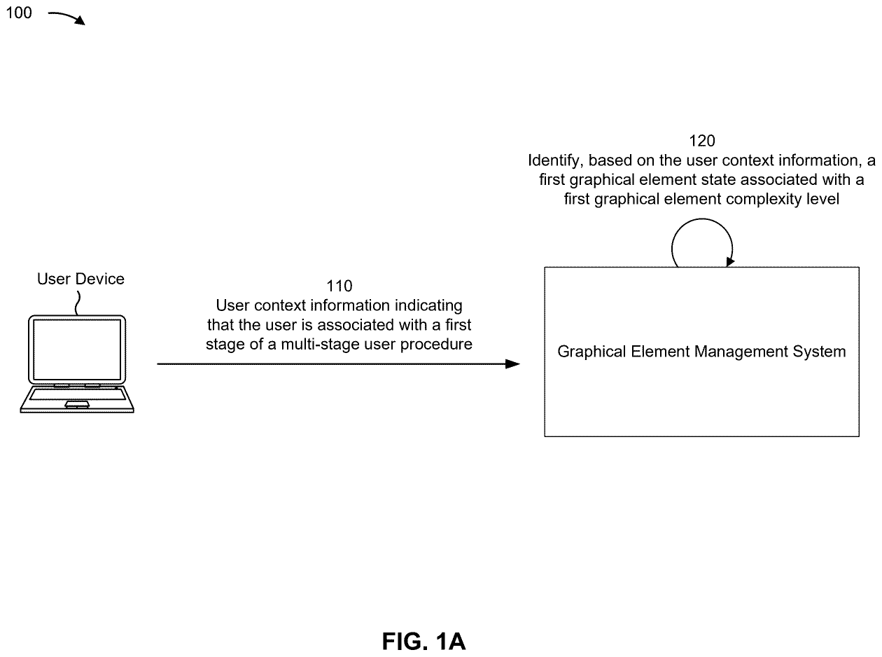

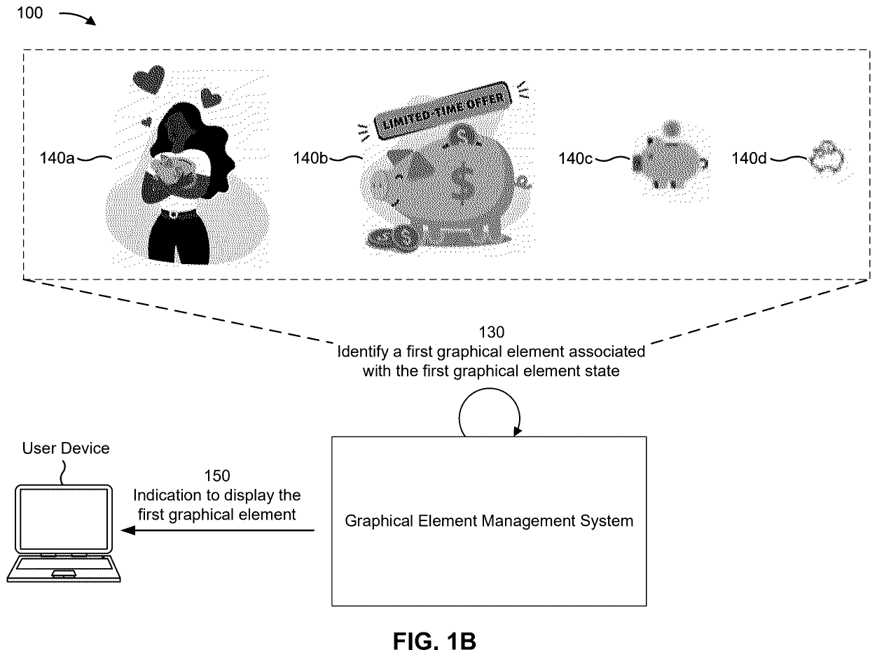

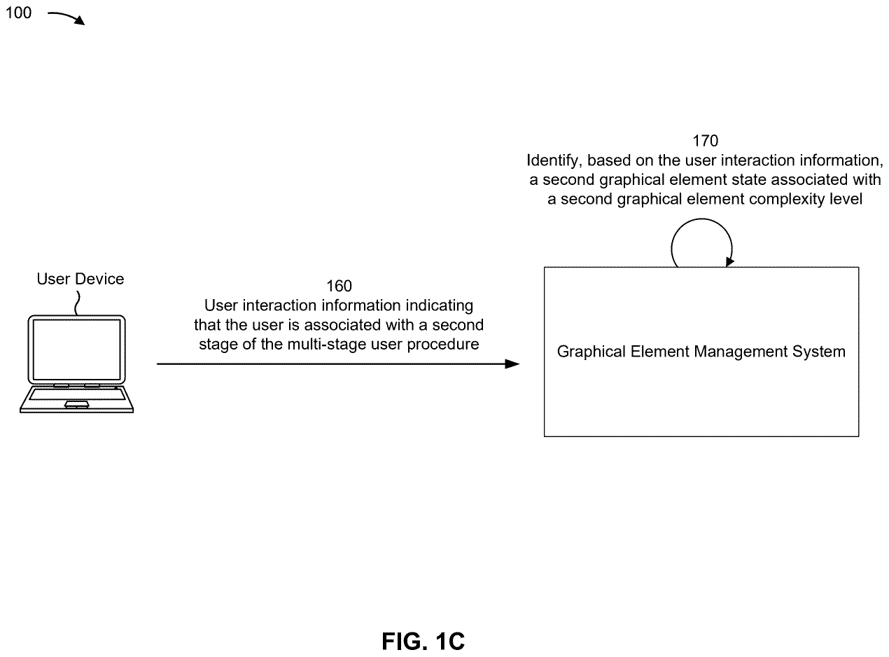

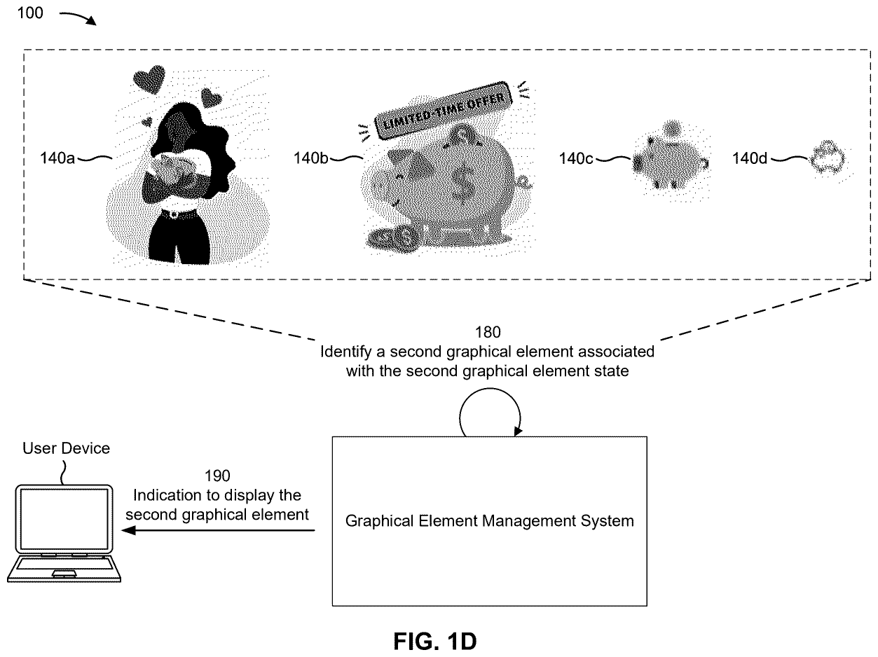

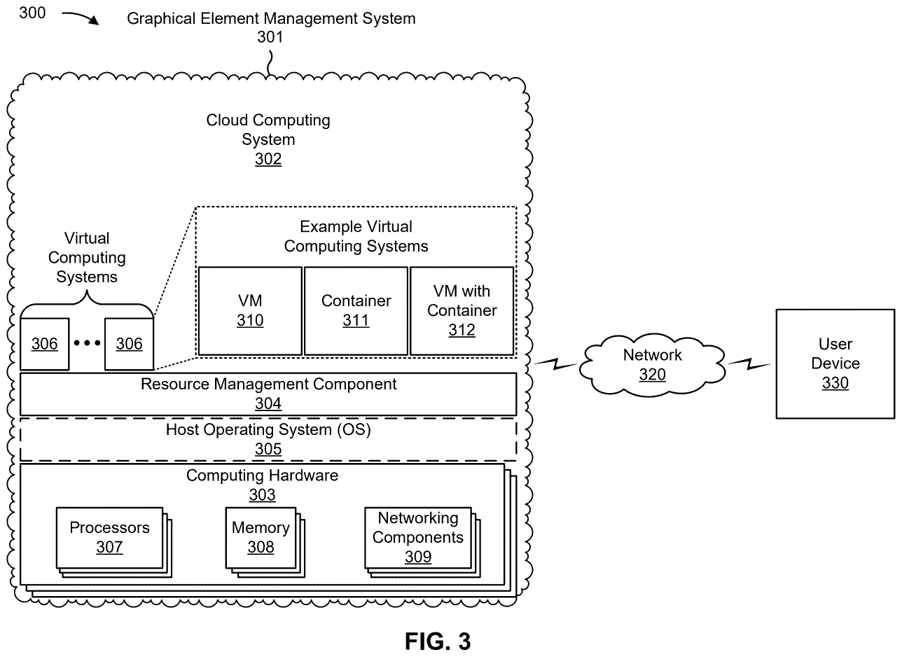

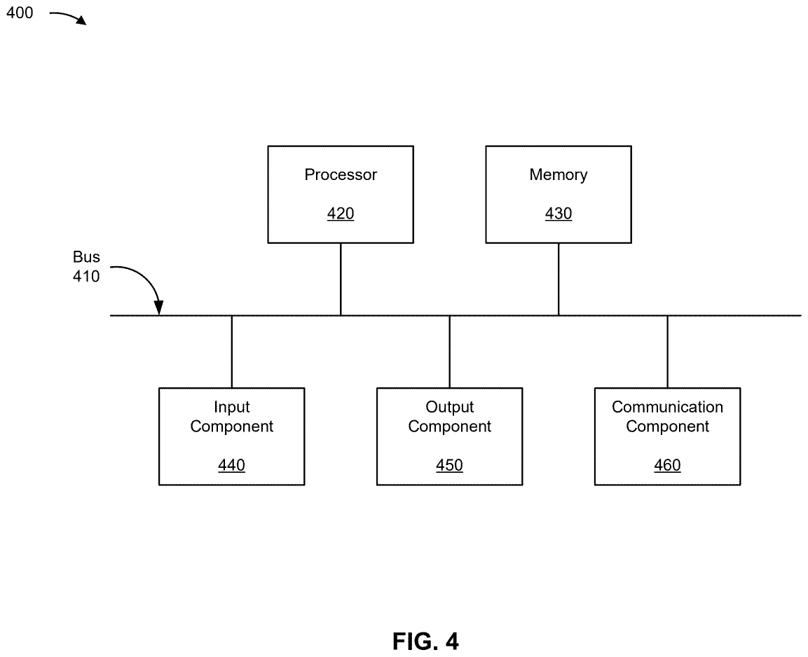

FIGS. 1A-1D are diagrams of an example implementation 100 associated with graphical element management. As shown in FIGS. 1A-1D, example implementation 100 includes a user device and a graphical element management system. These devices are described in more detail below in connection with FIG. 3 and FIG. 4.

With reference to FIG. 1A, as shown by reference number 110, the user device may provide, and the graphical element management system may obtain, user context information indicating that a user is associated with a first stage of a multi-stage user procedure. The multi-stage user procedure may be a customer journey in which the user proceeds through multiple stages (e.g., web pages, phases to acquire goods or services, or the like). The user may be associated with the first stage of the multi-stage user procedure in that the user may have proceeded through any previous stages and not yet proceeded through the first stage. The user context information may include any suitable indication of where the user is in the customer journey, and may indicate user activity information (e.g., user browsing history, user purchasing history, or the like), user demographic information, or the like.

As shown by reference number 120, the graphical element management system may identify, based on the user context information, a first graphical element state associated with a first graphical element complexity level. A graphical element complexity level may represent a visual complexity of a graphical element (e.g., how detailed or simple the graphical element appears to the user). The graphical element management system may identify the first graphical element state based on the user context information in that the graphical element management system may identify the first graphical element state based on the first stage. For example, the current stage of the multi-stage user procedure may influence the identification of the first graphical element state.

In some aspects, the first graphical element complexity level may be associated with one or more of a graphical element color scheme, a quantity of graphical element layers, or graphical element dimensions. The graphical element color scheme, the quantity of graphical element layers, and the graphical element dimensions may impact the visual complexity of a graphical element. For example, a graphical element color scheme that is very colorful may increase the visual complexity of the graphical element, and a graphical element color scheme that is monochromatic may decrease the visual complexity. Additionally, or alternatively, a large quantity of graphical element layers may increase the visual complexity of the graphical element, and a small quantity of graphical element layers may decrease the visual complexity of the graphical element. Additionally, or alternatively, large graphical element dimensions may increase the visual complexity of the graphical element, and small graphical element dimensions may decrease the visual complexity of the graphical element.

In some aspects, the graphical element management system may identify the first graphical element state based on content of a web page. For example, the first graphical element state may depend on content that is displayed on the web page (e.g., content with which the user is interacting). For example, the information conveyed by the content on the web page may indicate that the user is at the first stage of the multi-stage user procedure (e.g., the content may contribute to the user context information). Additionally, or alternatively, the content may indicate a level of sophistication of the user (e.g., the first graphical element complexity level may be lower for more knowledgeable users). Additionally, or alternatively, the layout of the content (e.g., based on a design of the web page, dimensions of a screen of the user device, or the like) may impact the first graphical element complexity level.

With reference to FIG. 1B, as shown by reference number 130, the graphical element management system may identify a first graphical element associated with the first graphical element state. The first graphical element may include an icon, an image, text, or the like. The first graphical element may be associated with the first graphical element state in that the first graphical element may have a visual complexity commensurate with the first graphical element state. For example, the first graphical element may be assigned the first graphical element state. In the example shown in FIG. 1B, the graphical element management system may identify the first graphical element from among a plurality of graphical elements 140a-140d. In some examples, graphical elements 140a-140d may be variants of the same display element. For example, graphical element management system may select one of the graphical elements 140a-140d for display on a web page. As shown, the graphical elements 140a-140d have a range of visual complexities, with graphical element 140a the most complex (e.g., corresponding to a highest graphical element complexity level), and graphical element 140d the least complex (e.g., corresponding to a lowest graphical element complexity level). For example, if the first stage is an initial stage of the multi-stage user procedure, then the graphical element management system may select graphical element 140a. If the first stage is a later stage of the multi-stage user procedure, then the graphical element management system may select one of graphical elements 140b-140d (e.g., depending on how late the first stage is). In example implementation 100, the graphical element management system may identify the graphical element 140a.

In some aspects, the first graphical element may include one or more SVG elements. SVG is a file format capable of defining graphical elements that are scalable in size. The SVG elements may be code-driven, may include vector-drawn element data, and may be assigned classes that categorize the SVG elements. For example, a color of a vector may be changed in five different SVG elements used on the same web page using a class associated with the SVG elements (e.g., by pointing the class to adjusted color data). In some examples, the SVG elements (e.g., SVG templates, including text, static images, code, or the like) may be programmatically and/or dynamically rendered on-the-fly based on updated user context or interaction information.

In some aspects, the first graphical element may include one or more of an animation, text, a raster-based image, or vector information. For example, the first graphical element may flexibly incorporate any suitable combination of the animation, the text, the raster-based image, or the vector information. In some examples, the first graphical element may have multiple text or image formats.

As shown by reference number 150, the graphical element management system may transmit, and the user device may receive, an indication to display the first graphical element. In accordance with the indication to display the first graphical element, the user device may display the first graphical element on a display (e.g., a screen) of the user device. For example, the user device may display the web page with the first graphical element included therein.

With reference to FIG. 1C, as shown by reference number 160, the graphical element management system may receive user interaction information indicating that the user is associated with a second stage of the multi-stage user procedure. The user may be associated with the second stage of the multi-stage user procedure in that the user may have proceeded through any previous stages (e.g., including the first stage) and not yet proceeded through the second stage. The user interaction information may indicate how a user interacts with a web page, and the user interaction may occur via an input component, such as a mouse, a keyboard, a touchscreen, or the like. For example, the user may interact with a web page in such a way as to indicate that the user has completed the first stage and is proceeding to the second stage. In some examples, the user interaction may include a hover, selection (e.g., click), scroll, or the like. In some examples, the user interaction information may indicate a user engagement level (e.g., based on a length of time for which the user has not interacted with the web page).

As shown by reference number 170, the graphical element management system may identify, based on the user interaction information, a second graphical element state associated with a second graphical element complexity level. The graphical element management system may identify the second graphical element state based on the user interaction information in that the graphical element management system may identify the second graphical element state based on the user being associated with the second stage.

In some aspects, the second graphical element complexity level may be associated with one or more of a graphical element color scheme, a quantity of graphical element layers, or graphical element dimensions. The graphical element color scheme, the quantity of graphical element layers, and the graphical element dimensions may impact the visual complexity of a graphical element, as discussed above in connection with the first graphical element complexity level.

In some aspects, the graphical element management system may identify the second graphical element state based on content of a web page. For example, the second graphical element state may depend on content that is displayed on the web page (e.g., content with which the user is interacting). For example, the information conveyed by the content on the web page may indicate that the user is at the second stage of the multi-stage user procedure. Additionally, or alternatively, the content may indicate the level of sophistication of the user, the layout of the content, or the like, as discussed above in connection with the first graphical element complexity level.

With reference to FIG. 1D, as shown by reference number 180, the graphical element management system may identify a second graphical element that is associated with the second graphical element state. The second graphical element may include an icon, an image, text, or the like. The second graphical element may be associated with the second graphical element state in that the second graphical element may have a visual complexity commensurate with the second graphical element state. For example, the second graphical element may be assigned the second graphical element state. In the example shown in FIG. 1D, the graphical element management system may identify the second graphical element from among the plurality of candidate graphical elements 140a-140d. For example, the graphical element management system may select one of the graphical elements 140a-140d for display on a web page. For example, having selected the graphical element 140a for the first stage, the graphical element management system may select the graphical element 140b, graphical element 140c, or graphical element 140d for the second stage. In example implementation 100, the graphical element management system may identify the graphical element 140c. Thus, for example, the graphical element management system may select more complex graphical elements (e.g., graphical element 140a) for the first stage and less complex graphical elements (e.g., graphical element 140c) for the second stage. In some examples, the graphical element management system may use a state machine to manage transitions between different graphical element states (e.g., from the first graphical element state to the second graphical element state). For example, the graphical element management system may use the state machine to smoothly transition from more complex graphical elements to less complex graphical elements.

In some aspects, the second graphical element may include one or more SVG elements, as discussed above in connection with the first graphical element. In some aspects, the second graphical element may include one or more of an animation, text, a raster-based image, or vector information, as discussed above in connection with the first graphical element.

In some aspects, the graphical element management system may identify the second graphical element state based on historical user interaction information. For example, the historical user interaction information may indicate how the user and/or other users have previously interacted with one or more web page(s). For example, the historical user interaction information may indicate user engagement levels (e.g., how the user and/or the other users behaved before and/or after graphical elements of given complexities were displayed). In some examples, the graphical element management system may use one or more machine learning (ML) techniques and/or one or more artificial intelligence (AI) large language models (LLMs) to smoothly transition from more complex graphical elements to less complex graphical elements. In some examples, the graphical element management system may integrate the ML technique(s) and/or AI LLM(s) to continuously learn from the historical user interaction information and thereby refine graphical element adaptation strategies. In some examples, the graphical element management system may use the ML technique(s) and/or AI LLM(s) to identify the second graphical element based on the historical user interaction information. Thus, the graphical element management system may analyze user behavior, user interactions, and/or user context in real-time, and dynamically adjust graphical element complexity and representations to match conditional graphical element states.

As shown by reference number 190, the graphical element management system may transmit an indication to display the second graphical element. In accordance with the indication to display the second graphical element, the user device may display the second graphical element on a display (e.g., a screen) of the user device. For example, the user device may display the web page with the second graphical element included therein. In some examples, the user device may use one or more animations or transitions to smoothly and dynamically change between graphical element states (e.g., from the first graphical element to the second graphical element). Thus, the graphical element management system may dynamically adjust graphical element complexity with a user interface displayed on the web page, transitioning graphical elements from higher complexity to lower complexity based on user behavior, user interactions, and/or user context.

In some aspects, the graphical element management system may transmit the indication to display the second graphical element in accordance with a lazy loader. The lazy loader may cache instructions to generate graphical elements on-the-fly (e.g., based on indications to display graphical elements received from the graphical element management system). For example, the lazy loader may load the second graphical element upon receiving the indication to display the second graphical element. For example, rather than loading all graphical elements 140a-140d, the lazy loader may first load the graphical element 140a and, upon receiving the indication to display the second graphical element, then load the graphical element 140c.

In some aspects, the graphical element management system may transmit the indication to display the second graphical element in accordance with an asynchronous loader. The asynchronous loader may preemptively cache one or more of graphical elements 140a-140d based on ongoing user activity (e.g., using onload context caching). For example, the asynchronous loader may analyze ongoing user activity and interaction patterns as the web page loads. For example, the asynchronous loader may load the second graphical element before the user has scrolled down to the part of the web page where the asynchronous loader is displayed.

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

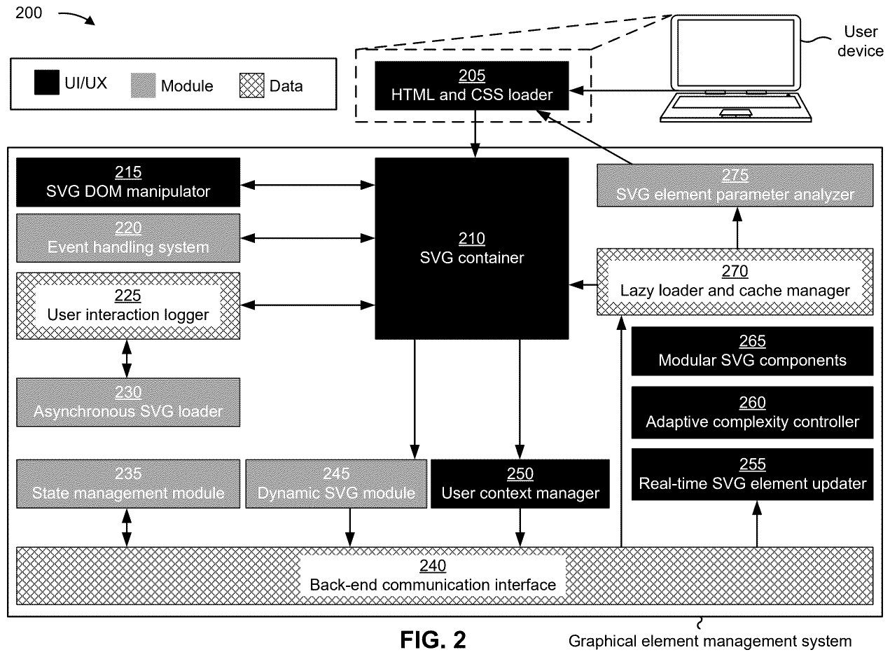

FIG. 2 is a diagram of an example functional workflow 200 associated with adaptive cursor or tooltip management. The functional workflow 200 involves the user device, which may include a hypertext markup language (HTML) and cascading style sheets (CSS) loader 205, and the graphical element management system, which may include an SVG container 210, an SVG document object model (DOM) manipulator 215, an event handling system 220, a user interaction logger 225, an asynchronous SVG loader 230, a state management module 235, a back-end communication interface 240, a dynamic SVG module 245, a user context manager 250, a real-time SVG element updater 255, an adaptive complexity controller 260, modular SVG components 265, a lazy loader and cache manager 270, and an SVG element parameter analyzer 275.

The HTML and CSS loader 205 may parse an HTML document and load one or more CSS files, which may establish a basic structure and styles for the SVG container 210. The SVG container 210 may include one or more modular SVG packages that include one or more SVG elements within modular containers. The SVG container 210 may incorporate one or more animations or transitions to provide smooth, dynamic visual effects. Thus, the SVG elements may function as executable, object-oriented components tailored for specific web page elements. In some examples, the SVG container 210 may integrate the modular SVG package(s) with internal logic to interact with other interface elements.

The SVG DOM manipulator 215 may access and modify internal SVG elements, adjusting the appearance of one or more graphical elements by altering graphical element attributes (e.g., fill, stroke, visibility, or the like). For example, an SVG image may be manipulated in the DOM such that SVGs (and SVG child elements) may have classes, transitions, respond to user interactions, or the like. In some examples, SVG elements may be manipulated instantly and synchronously using classes, even if the manipulation is triggered after DOM load. The event handling system 220 may manage user interactions with the SVG elements, providing interactive feedback through animations or visual changes. The user interaction logger 225 may attach event listeners to SVG elements in order to log user interactions and send user interaction information to the back-end communication interface 240 for analysis.

The asynchronous SVG loader 230 may be an asynchronous loader that loads SVG files asynchronously and injects the SVG files into the DOM without blocking a main thread. The state management module 235 may maintain the SVG element states of each SVG element. The back-end communication interface 240 may configure application programming interface (API) endpoints, handle communication with back-end services (e.g., authentication services) to receive real-time SVG element adjustment instructions, monitor user interactions, digital context, and system logic, send instructions to front-end components to dynamically adjust SVG element states based on monitored conditions, or the like.

The dynamic SVG module 245 may initialize instructions responsible for determining user context, manipulating SVG icons, and communicating with back-end services. The user context manager 250 may retrieve user context information (e.g., user context data) from cookies or storage to establish a current stage of the multi-stage user procedure, which may influence graphical element complexity. The real-time SVG element updater 255 may receive instructions from the back-end communication interface to dynamically adjust SVG icons so as to adapt to updated user context information, among other examples.

The adaptive complexity controller 260 may adjust SVG element complexity by toggling the visibility of SVG groups or layers according to defined complexity levels, user context information, or the like. The modular SVG components 265 may structure each SVG element as a reusable module with encapsulated SVG markup, classes, and instructions (e.g., code) for interactions. The lazy loader and cache manager 270 may implements lazy loading for SVG elements not immediately visible and retrieve cached icons. The SVG element parameter analyzer 275 may identify SVG elements and appropriate SVG complexity levels based on page content, user context information, or the like.

As indicated above, FIG. 2 is provided as an example. Other examples may differ from what is described with regard to FIG. 2.

Identifying a graphical element state associated with a graphical element complexity level based on user context information and/or user interaction information may help to conserve computing resources and/or network resources. For example, computing resources and/or network resources may be conserved by tailoring a graphical element complexity level to the user. For example, identifying the graphical element state may help to ensure that a graphical element associated with the graphical element state is not overly complex, thereby conserving computing resources that would otherwise be used for the user device to generate and display overly complex graphical elements and that are needed for one or more server devices to serve overly complex graphical elements to the user device, and consume excessive network resources that are needed for communications between the user device and the server device. Additionally, or alternatively, identifying the graphical element state may help to ensure that a graphical element associated with the graphical element state is not under-detailed, and thereby reduce an amount of navigation performed by the user to other web pages, which may conserve computing resources that would otherwise be used for the user device to generate and display the web pages and that are needed for one or more server devices to serve the web pages to the user device, and consume excessive network resources that are needed for communications between the user device and the server device. Furthermore, the graphical element state being associated with the graphical element complexity level may help to streamline how the graphical element management system tracks and updates graphical elements, thereby conserving computing resources (e.g., processing resources and memory resources) that would otherwise be used for tracking graphical elements and determining when and how to update display of the graphical elements. For example, graphical element states may ensure consistent behavior across different user interactions and user journey stages. Furthermore, identifying a graphical element state associated with a graphical element complexity level based on user context information and/or user interaction information may make data easier to access by enhancing a user interface, thereby improving a user experience, user engagement, user interaction, decision-making, and accessibility at each stage of a multi-stage user procedure, thereby enhancing user-friendliness of a user device and the user interface, and improving the ability of a user to use the user device. For example, the system may improve user interaction by personalizing graphical element complexity, thereby enhancing recognition and navigation throughout the user journey. Additionally, or alternatively, identifying a graphical element state associated with a graphical element complexity level may enable a cohesive and context-aware user experience by providing a personalized, efficient, engaging, and responsive user interface and tailored, engaging, and accessible navigation (e.g., by providing smooth and contextually appropriate changes to a graphical interface display).

Transmitting the indication to display the second graphical element in accordance with a lazy loader may enable an efficient loading and caching strategy that enhances performance and reduces data load and/or data consumption. For example, the lazy loader may reduce computing resources (e.g., processing resources and memory resources) that would otherwise be used for loading all possible graphical elements for each page. For example, instead of loading all possible graphical elements, the user device may load only the graphical elements that are appropriate based on user context information and/or user interaction information. For example, the lazy loader may reduce data consumption on a DOM, ultimately enabling the user device to avoid displaying the graphical elements. Additionally, or alternatively, the lazy loader may conserve energy by reducing a total length of time for which a graphic engine of the user device is engaged.

Transmitting the indication to display the second graphical element in accordance with an asynchronous loader may enable an efficient, preemptive caching strategy that reduces load times, reduces repeated requests, and quickens graphical element transitions based on real-time engagement. As a result, the asynchronous loader may reduce computing and networking resources (e.g., processing resources, memory resources, bandwidth resources, or the like) that would otherwise be used for long load times, repeated requests, and slow graphical element transitions.

FIG. 3 is a diagram of an example environment 300 in which systems and/or methods described herein may be implemented. As shown in FIG. 3, environment 300 may include a graphical element management system 301, which may include one or more elements of and/or may execute within a cloud computing system 302. The cloud computing system 302 may include one or more elements 303-312, as described in more detail below. As further shown in FIG. 3, environment 300 may include a network 320, and/or a user device 330. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the graphical element management system 301 may include one or more elements 303-312 of the cloud computing system 302, may execute within the cloud computing system 302, and/or may be hosted within the cloud computing system 302, in some implementations, the graphical element management system 301 may not be cloud-based (e.g., may be implemented outside of a cloud computing system) or may be partially cloud-based. For example, the graphical element management system 301 may include one or more devices that are not part of the cloud computing system 302, such as device 400 of FIG. 4, which may include a standalone server or another type of computing device. The graphical element management system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The user device 330 may include one or more devices capable of receiving, generating, storing, processing, and/or providing information associated with graphical element management, as described elsewhere herein. The user device 330 may include a communication device and/or a computing device. For example, the user device 330 may include a wireless communication device, a mobile phone, a user equipment, a laptop computer, a tablet computer, a desktop computer, a wearable communication device (e.g., a smart wristwatch, a pair of smart eyeglasses, or the like), or a similar type of device.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with graphical element management. The device 400 corresponds to one or more of the graphical element management system 301 and/or the user device 330. In some implementations, the graphical element management system 301 and/or the user device 330 include one or more devices 400 and/or one or more components of the device 400. In the example shown in FIG. 4, the device 400 includes a bus 410, a processor 420, a memory 430, an input component 440, an output component 450, and/or a communication component 460.

The bus 410 includes one or more components that enable wired and/or wireless communication among the components of the device 400. The bus 410 couples together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 includes a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory, such as random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). In some implementations, the memory 430 is a non-transitory computer-readable medium. The memory 430 stores information, one or more instructions, and/or software (e.g., one or more software applications) related to the operation of the device 400. In some implementations, the memory 430 includes one or more memories that are coupled (e.g., communicatively coupled) to one or more processors (e.g., processor 420), such as via the bus 410. Communicative coupling between a processor 420 and a memory 430 enables the processor 420 to read and/or process information stored in the memory 430 and/or to store information in the memory 430.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

In some implementations, the device 400 performs one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

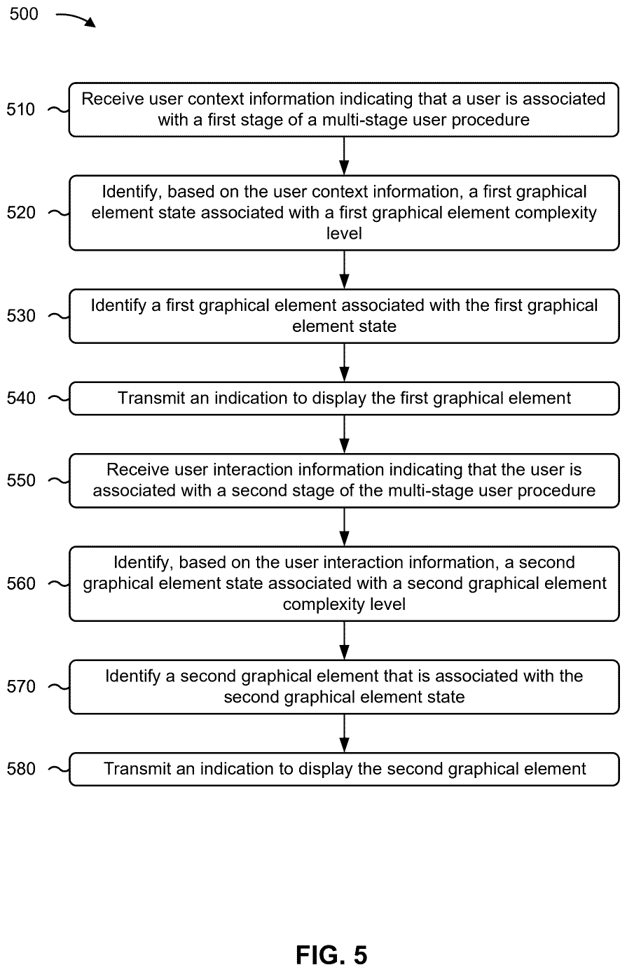

FIG. 5 is a flowchart of an example process 500 associated with graphical element management. In some implementations, one or more process blocks of FIG. 5 may be performed by the graphical element management system 301. In some implementations, one or more process blocks of FIG. 5 may be performed by another device or a group of devices separate from or including the graphical element management system 301, such as the user device 330. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving user context information indicating that a user is associated with a first stage of a multi-stage user procedure (block 510). For example, the graphical element management system 301 (e.g., using processor 420, memory 430, input component 440, and/or communication component 460) may receive user context information indicating that a user is associated with a first stage of a multi-stage user procedure, as described above in connection with reference number 110 of FIG. 1A. As an example, the user context information may indicate where the user is in the multi-stage user procedure, and may include user activity information (e.g., user browsing history, user purchasing history, or the like), user demographic information, or the like.

As further shown in FIG. 5, process 500 may include identifying, based on the user context information, a first graphical element state associated with a first graphical element complexity level (block 520). For example, the graphical element management system 301 (e.g., using processor 420 and/or memory 430) may identify, based on the user context information, a first graphical element state associated with a first graphical element complexity level, as described above in connection with reference number 120 of FIG. 1A. As an example, the first graphical element complexity level may represent a visual complexity of a graphical element.

As further shown in FIG. 5, process 500 may include identifying a first graphical element associated with the first graphical element state (block 530). For example, the graphical element management system 301 (e.g., using processor 420 and/or memory 430) may identify a first graphical element associated with the first graphical element state, as described above in connection with reference number 130 of FIG. 1B. As an example, the first graphical element may include an icon, an image, text, or the like.

As further shown in FIG. 5, process 500 may include transmitting an indication to display the first graphical element (block 540). For example, the graphical element management system 301 (e.g., using processor 420, memory 430, and/or communication component 460) may transmit an indication to display the first graphical element, as described above in connection with reference number 150 of FIG. 1B. As an example, the indication may prompt a user device may display the first graphical element on a screen of the user device.

As further shown in FIG. 5, process 500 may include receiving user interaction information indicating that the user is associated with a second stage of the multi-stage user procedure (block 550). For example, the graphical element management system 301 (e.g., using processor 420, memory 430, input component 440, and/or communication component 460) may receive user interaction information indicating that the user is associated with a second stage of the multi-stage user procedure, as described above in connection with reference number 160 of FIG. 1C. As an example, the user interaction information may indicate how a user interacts with a web page, and may occur via an input component, such as a mouse, a keyboard, a touchscreen, or the like.

As further shown in FIG. 5, process 500 may include identifying, based on the user interaction information, a second graphical element state associated with a second graphical element complexity level (block 560). For example, the graphical element management system 301 (e.g., using processor 420 and/or memory 430) may identify, based on the user interaction information, a second graphical element state associated with a second graphical element complexity level, as described above in connection with reference number 170 of FIG. 1C. As an example, the second graphical element complexity level may represent a visual complexity of a graphical element.

As further shown in FIG. 5, process 500 may include identifying a second graphical element that is associated with the second graphical element state (block 570). For example, the graphical element management system 301 (e.g., using processor 420 and/or memory 430) may identify a second graphical element that is associated with the second graphical element state, as described above in connection with reference number 180 of FIG. 1D. As an example, the second graphical element may include an icon, an image, text, or the like.

As further shown in FIG. 5, process 500 may include transmitting an indication to display the second graphical element (block 580). For example, the graphical element management system 301 (e.g., using processor 420, memory 430, and/or communication component 460) may transmit an indication to display the second graphical element, as described above in connection with reference number 190 of FIG. 1D. As an example, the indication may prompt the user device to display the second graphical element on the screen of the user device.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1D and 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for graphical element management, the system comprising:
one or more memories; and
one or more processors, communicatively coupled to the one or more memories, configured to:
receive user context information indicating that a user is associated with a first stage of a multi-stage user procedure;
identify, based on the user context information, a first graphical element state associated with a first graphical element complexity level;
identify a first graphical element associated with the first graphical element state, wherein the first graphical element comprises a first scalable vector graphics (SVG) element;
transmit an indication to display the first graphical element;
receive user interaction information indicating that the user is associated with a second stage of the multi-stage user procedure;
identify, based on the user interaction information, a second graphical element state associated with a second graphical element complexity level;
identify a second graphical element that is associated with the second graphical element state, wherein the second graphical element comprises an SVG element; and
transmit an indication to display the second graphical element.

2. The system of claim 1, wherein one or more of the first graphical element complexity level or the second graphical element complexity level are associated with one or more of a graphical element color scheme, a quantity of graphical element layers, or graphical element dimensions.

3. The system of claim 1, wherein one or more of the first graphical element or the second graphical element comprise one or more of an animation, text, a raster-based image, or vector information.

4. The system of claim 1, wherein the one or more processors, to identify the first graphical element state, are configured to identify the first graphical element state based on content of a web page.

5. The system of claim 1, wherein the one or more processors, to transmit the indication to display the second graphical element, are configured to transmit the indication to display the second graphical element in accordance with a lazy loader.

6. The system of claim 1, wherein the one or more processors, to transmit the indication to display the second graphical element, are configured to transmit the indication to display the second graphical element in accordance with an asynchronous loader.

7. The system of claim 1, wherein the one or more processors, to identify the second graphical element state, are configured to identify the second graphical element state based on historical user interaction information.

8. A method of graphical element management, comprising:
receiving user context information indicating that a user is associated with a first stage of a multi-stage user procedure;
identifying, based on the user context information, a first graphical element state associated with a first graphical element complexity level;
identifying a first graphical element associated with the first graphical element state;
transmitting an indication to display the first graphical element;
receiving user interaction information indicating that the user is associated with a second stage of the multi-stage user procedure;
identifying, based on the user interaction information, a second graphical element state associated with a second graphical element complexity level;
identifying a second graphical element that is associated with the second graphical element state; and
transmitting an indication to display the second graphical element.

9. The method of claim 8, wherein one or more of the first graphical element complexity level or the second graphical element complexity level are associated with one or more of a graphical element color scheme, a quantity of graphical element layers, or graphical element dimensions.

10. The method of claim 8, wherein the first graphical element and the second graphical element comprise scalable vector graphics (SVG) elements.

11. The method of claim 8, wherein one or more of the first graphical element or the second graphical element comprise one or more of an animation, text, a raster-based image, or vector information.

12. The method of claim 8, wherein identifying the first graphical element state includes identifying the first graphical element state based on content of a web page.

13. The method of claim 8, wherein transmitting the indication to display the second graphical element includes transmitting the indication to display the second graphical element in accordance with a lazy loader.

14. The method of claim 8, wherein transmitting the indication to display the second graphical element includes transmitting the indication to display the second graphical element in accordance with an asynchronous loader.

15. The method of claim 8, wherein identifying the second graphical element state includes identifying the second graphical element state based on historical user interaction information.

16. A non-transitory computer-readable medium storing a set of instructions, the set of instructions comprising:
one or more instructions that, when executed by one or more processors of a device, cause the device to:
receive user context information indicating that a user is associated with a first stage of a multi-stage user procedure;
identify, based on the user context information, a first graphical element state associated with a first graphical element complexity level;
identify a first graphical element associated with the first graphical element state;
transmit an indication to display the first graphical element;
receive user interaction information indicating that the user is associated with a second stage of the multi-stage user procedure;
identify, based on the user interaction information, a second graphical element state associated with a second graphical element complexity level;
identify a second graphical element that is associated with the second graphical element state; and
transmit an indication to display the second graphical element in accordance with a lazy loader.

17. The non-transitory computer-readable medium of claim 16, wherein one or more of the first graphical element complexity level or the second graphical element complexity level are associated with one or more of a graphical element color scheme, a quantity of graphical element layers, or graphical element dimensions.

18. The non-transitory computer-readable medium of claim 16, wherein the first graphical element and the second graphical element comprise scalable vector graphics (SVG) elements.

19. The non-transitory computer-readable medium of claim 16, wherein one or more of the first graphical element or the second graphical element comprise one or more of an animation, text, a raster-based image, or vector information.

20. The non-transitory computer-readable medium of claim 16, wherein the one or more instructions, that cause the device to identify the first graphical element state, cause the device to identify the first graphical element state based on content of a web page.
